(19) United States
(12) Patent Application Publication
(10) Pub. No.: US 2022/0066978 A1
(43) Pub. Date: Mar. 3, 2022

(54) MISSED CLOCK COMPENSATION FOR RADIO FREQUENCY FRONT END TIMED-TRIGGER ACCURACY

(71) Applicant: QUALCOMM Incorporated, San Diego, CA (US)

(72) Inventors: Lalan Jee MISHRA, San Diego, CA (US); Richard Dominic WIETFELDT, San Diego, CA (US); Umesh SRIKANTIAH, San Diego, CA (US); Karthik MANIVANNAN, San Diego, CA (US)

(21) Appl. No.: 17/005,158

(22) Filed: Aug. 27, 2020

(51) Int. Cl. G06F 13/42

(52) U.S. Cl. CPC G06F 13/4291; H04B 1/40

(57) ABSTRACT

Systems, methods, and apparatus improve accuracy of trigger timing by compensating for clock pulses that are suppressed when datagrams are transmitted over a serial bus. A method includes configuring an initial value of an output of a counter in a timing circuit, enabling the counter to count pulses in a clock signal received from the serial bus, determining that a datagram is being transmitted on the serial bus while the counter is counting the pulses in the clock signal, providing a timing value that represents a current value of the output of the counter adjusted to compensate for one or more clock pulses suppressed during transmission of the datagram, and providing a trigger when the timing value reaches a maximum value or a minimum value. The counter may be a countdown counter and two clock pulses may be suppressed for each sequence start condition transmitted on the serial bus.

### TECHNICAL FIELD

The present disclosure relates generally to serial communication over a shared serial bus and, more particularly, to optimizing timing of time-critical triggers initiated by transmissions over the shared serial bus.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a multi-drop serial bus or a parallel bus. General-purpose serial interfaces known in the industry include the Inter-Integrated Circuit (I2C or I²C) serial interface and its derivatives and alternatives.

The Mobile Industry Processor Interface (MIPI) Alliance defines standards for the Improved Inter-Integrated Circuit (I3C) serial interface, the Radio Frequency Front-End (RFFE) interface, the System Power Management Interface (SPMI) and other interfaces. These interfaces may be used to connect processors, sensors and other peripherals, for example. In some interfaces, multiple bus masters are coupled to the serial bus such that two or more devices can serve as bus master for different types of messages transmitted on the serial bus. SPMI protocols define a hardware interface that may be implemented between baseband or application processors and peripheral components. In some instances, SPMI protocols are implemented to support power management operations within a device.

The RFFE interface provides a communication interface that may be used for controlling various radio frequency (RF) front-end devices, including power amplifier (PA), low-noise amplifiers (LNAs), antenna tuners, filters, sensors, power management devices, switches, and the like. These devices may be collocated in a single IC device or provided in multiple IC devices. In a mobile communication device, multiple antennas and radio transceivers may be provided to support multiple concurrent RF links. In some instances, a serial bus may enable one device to trigger an action in another device at a precise time.

There is an ongoing need to support accurate and reliable triggers, initiated, enabled or managed through serial buses.

### SUMMARY

Certain aspects of the disclosure relate to systems, apparatus, methods and techniques that can improve accuracy of triggers that are configured and/or initiated through transmissions over a serial bus, including when bus-latency is affected by congestion and other effects. In one aspect of the disclosure, trigger timing issues can be avoided through the use of a trigger delay mechanism initiated in response to trigger configuration information transmitted in advance of the desired trigger actuation time. In one aspect of the disclosure, the accuracy of trigger timing can be improved by compensating for clock pulses that are suppressed when datagrams are transmitted over the serial bus.

In various aspects of the disclosure, a data communication method performed at a device coupled to a serial bus includes configuring an initial value of an output of a counter in a timing circuit, enabling the counter to count pulses in a clock signal received from the serial bus, determining that a datagram is being transmitted on the serial bus while the counter is counting the pulses in the clock signal, providing a timing value that represents a current value of the output of the counter adjusted to compensate for one or more clock pulses suppressed during transmission of the datagram, and providing a trigger when the timing value reaches a maximum value or a minimum value.

In various aspects of the disclosure, a data communication apparatus has an interface circuit adapted to couple the data communication apparatus to a serial bus and configured to receive a clock signal from the serial bus, a counter configured to count pulses in the clock signal, a datagram detector circuit configured to determine that a datagram is being transmitted on the serial bus while the counter is counting the pulses in the clock signal, a controller that configures an initial value of an output of the counter, and enables the counter to count the pulses in the clock signal, and an arithmetic circuit configured to provide a timing value that represents a current value of the output of the counter adjusted to compensate for one or more clock pulses suppressed during transmission of the datagram. A trigger may be provided when the timing value reaches a maximum value or a minimum value.

In various aspects of the disclosure, a processor-readable storage medium has one or more instructions stored thereon which, when executed by at least one processor of a processing circuit in a receiver, cause the at least one processor to configure an initial value of an output of a counter in a timing circuit, enable the counter to count pulses in a clock signal received from the serial bus, determine that a datagram is being transmitted on the serial bus while the counter is counting the pulses in the clock signal, provide a timing value that represents a current value of the output of the counter adjusted to compensate for one or more clock pulses suppressed during transmission of the datagram, and provide a trigger when the timing value reaches a maximum value or a minimum value.

In various aspects of the disclosure, a data communication apparatus has means for timing a trigger, the means for timing the trigger including a counter configured to count pulses in a clock signal received from the serial bus. An output of the counter may be initially configured with an initial value. The data communication apparatus may have means for determining that a datagram is being transmitted on the serial bus while the counter is counting the pulses in the clock signal, and means for providing a timing value that represents a current value of the output of the counter adjusted to compensate for one or more clock pulses suppressed during transmission of the datagram. The trigger may be provided when the timing value reaches a maximum value or a minimum value.

In some implementations, the datagram is configured in accordance with RFFE protocols or SPMI protocols. Two clock pulses in the clock signal may be suppressed during transmission of the datagram.

In some implementations, the device, apparatus, processor or another circuit may determine that the datagram is being transmitted on the serial bus by detecting a sequence start condition (SSC) on the serial bus Two clock pulses in the clock signal are suppressed during transmission of the SSC.

In some implementations, the counter is configured to count pulses by counting down from the initial value. The device, apparatus, processor or another circuit may provide the timing value by subtracting a number representing the one or more clock pulses suppressed during transmission of the datagram from the current value of the counter output. The device, apparatus, processor or another circuit may provide the trigger when the timing value reaches zero.

In some implementations, the counter is configured to count pulses by counting up from the initial value. The device, apparatus, processor or another circuit may provide the timing value by adding a number representing the one or more clock pulses suppressed during transmission of the datagram to the current value of the counter output. The device, apparatus, processor or another circuit may provide the trigger when the timing value reaches zero.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device configuration for coupling various radio frequency front-end devices using multiple RFFE buses.

FIG. 4 illustrates actuation of triggers in accordance with certain aspects disclosed herein.

FIG. 5 illustrates an example of a system that may be configured in accordance with certain aspects disclosed herein.

FIG. 6 illustrates datagram structures defined by RFFE protocols.

FIG. 7 illustrates transmission of an SSC provided in accordance with an RFFE protocol.

FIG. 8 illustrates accumulation of timing inaccuracies caused by transmission of datagrams during timed-trigger operation.

FIG. 9 illustrates a trigger circuit configured to compensate for suppressed clock pulses during timed-trigger operation in accordance with certain aspects of the disclosure.

FIG. 10 illustrates one example of an apparatus employing a processing circuit that may be adapted according to certain aspects disclosed herein.

FIG. 11 is a flowchart that illustrates a method that may be performed by a master device coupled to a serial bus in accordance with certain aspects disclosed herein.

FIG. 12 illustrates a first example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include application-specific IC (ASIC) devices, SoCs and/or other IC devices often employ a shared communication interface that may include a serial bus or other data communication link to connect processors with modems and other peripherals. The serial bus or other data communication link may be operated in accordance with multiple standards or protocols defined. For example, the serial bus may be operated in accordance with an I2C, I3C, SPMI, and/or RFFE protocol, or another protocol that may be configured for half-duplex operation. Increased utilization of serial buses, and/or the imposition of more stringent timing constraints in support of applications, peripherals and sensors can result in demand for reduced transmission latencies. Transmission latency may include the time required to terminate a transaction in process on the serial bus, bus turnaround (between transmit mode and receive mode), bus arbitration and/or command transmissions specified by protocol.

Certain operations in a radio frequency IC (RFIC) require very low-latency communications. For example, configuration and reconfiguration of circuits used to drive multiple antennas may generate large volumes of messages, commands and signaling directed to multiple radio frequency components. In many instances, the messages may include configuration parameters that are to be applied at a time determined by a controlling device. In some instances, triggers may be sent to activate a configuration defined by previously provided configuration parameters. In one example, triggers may be sent to initiate or actuate a sequence of configurations or actions in a radio frequency device according to a defined timeline. Congestion and bus-latency can result in mistiming of triggers when the triggers are configured and/or initiated through transmissions over a serial bus.

Certain aspects disclosed herein relate to certain timing issues that can arise when triggers are preconfigured and actuated based on timers. Triggers may be implemented by transmitting trigger configuration before the desired trigger actuation time and initiating one or more timers. The triggers are actuated when the timers expire. In conventional systems, the timers may be implemented using a counter clocked by a clock signal provided by the bus master. The bus master provides the clock signal during idle periods and while a transaction is being conducted through the serial bus. However, the clock signal is suppressed when certain control signaling is being transmitted.

In one example, a data communication method performed at a device coupled to a serial bus includes configuring an initial value of an output of a counter in a timing circuit, enabling the counter to count pulses in a clock signal received from the serial bus, determining that a datagram is being transmitted on the serial bus while the counter is counting the pulses in the clock signal, providing a timing value that represents a current value of the output of the counter adjusted to compensate for one or more clock pulses suppressed during transmission of the datagram, and providing a trigger when the timing value reaches a maximum value or a minimum value.

Certain aspects disclosed herein may be applicable to a serial bus operated in accordance with an I2C, I3C, SPMI, and/or RFFE protocol, or other protocol. Certain aspects are applicable to a serial bus operated in half-duplex mode or full-duplex mode. Certain aspects are applicable to point-to-point interfaces including UART-based interfaces, line multiplexed UART (LM-UART) interfaces, and virtual GPIO (VGI) and messaging interfaces. Certain aspects are applicable to multipoint interfaces and/or interfaces when operated in point-to-point mode.

### Examples Of Apparatus That Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

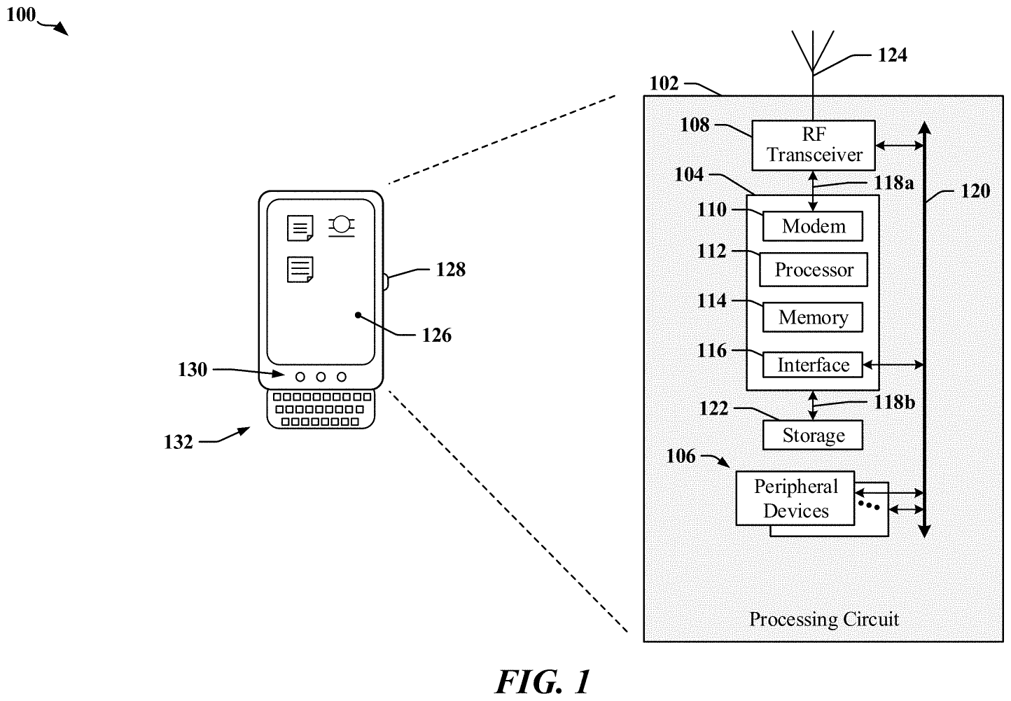

FIG. 1 illustrates an example of an apparatus 100 that employs a data communication bus. The apparatus 100 may include a processing circuit 102 that has multiple circuits or devices 104, 106 and/or 108, and which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or in the processor-readable storage 122. The ASIC 104 may access its on-board memory 114, the processor-readable storage 122, and/or storage external to the processing circuit 102. The on-board memory 114 and/or the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable communication between certain devices 104, 106, and/or 108. In one example, the ASIC 104 may include a bus interface circuit 116 that is implemented using a combination of circuits, counters, timers, control logic and other configurable circuits or modules. In one example, the bus interface circuit 116 may be configured to operate in accordance with standards-defined communication specifications or protocols. The processing circuit 102 may include or control a power management function that configures and manages the operation of the apparatus 100.

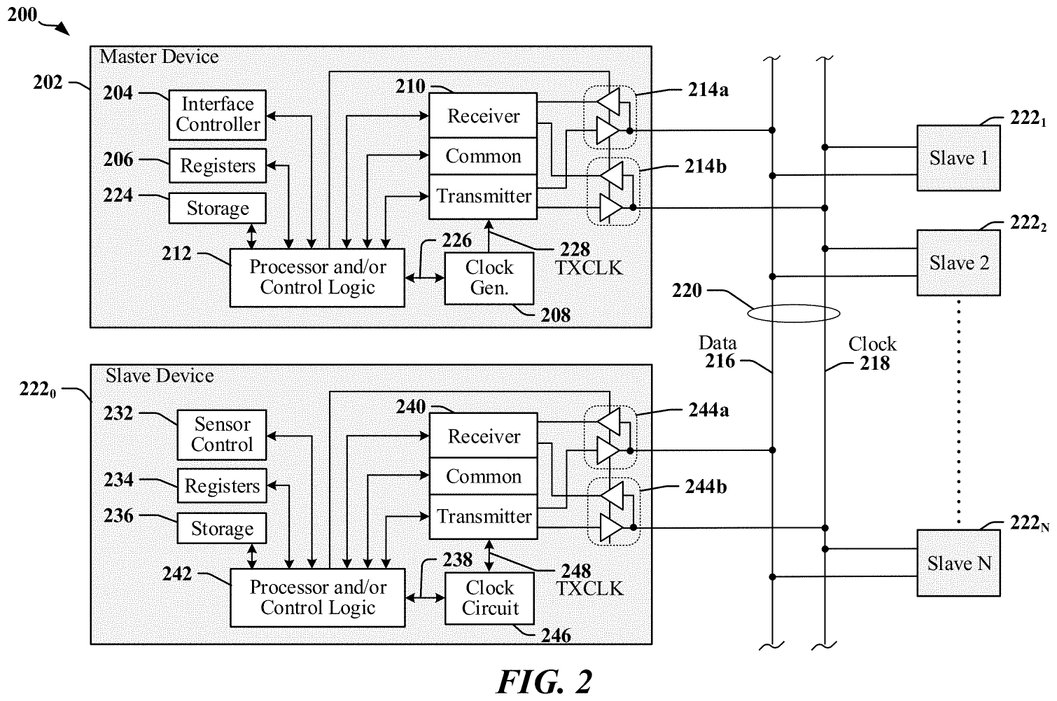

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an application processor, SoC or ASIC. In various implementations, the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communications between devices 202 and 222₀-222_{N} over the serial bus 220 is controlled by a bus master device 202. Certain types of bus can support multiple bus master devices 202.

In one example, a bus master device 202 may include an interface controller 204 that manages access to the serial bus, configures dynamic addresses for slave devices 222₀-222_{N} and/or generates a clock signal 228 to be transmitted on a clock line 218 of the serial bus 220. The bus master device 202 may include configuration registers 206 or other storage 224, and other control logic 212 configured to handle protocols and/or higher-level functions. The control logic 212 may include a processing circuit having a processing device such as a state machine, sequencer, signal processor or general-purpose processor. The bus master device 202 includes a transceiver 210 and line drivers/receivers 214a and 214b. The transceiver 210 may include receiver circuits, transmitter circuits and common circuits, where the common circuits may include timing, logic and storage circuits and/or devices. In one example, the transmitter circuits encode and transmit data based on timing in the clock signal 228 provided by a clock generation circuit 208. Other timing clock signals 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit that has a processing device such as a state machine, sequencer, signal processor or general-purpose processor. The transceiver 240 may include receiver circuits, transmitter circuits and common circuits, where the common circuits may include timing, logic and storage circuits and/or devices. In one example, the transmitter circuits encode and transmit data based on timing in a clock signal 248 provided by clock generation and/or recovery circuits 246. The clock signal 248 may be derived from a signal received from the clock line 218. Other timing clock signals 238 may be used by the control logic 242 and other functions, circuits or modules.

The serial bus 220 may be operated in accordance with RFFE, I2C, I3C, SPMI, or other protocol. In some instances, two or more devices 202, 222₀-222_{N} may be configured to operate as a bus master device on the serial bus 220.

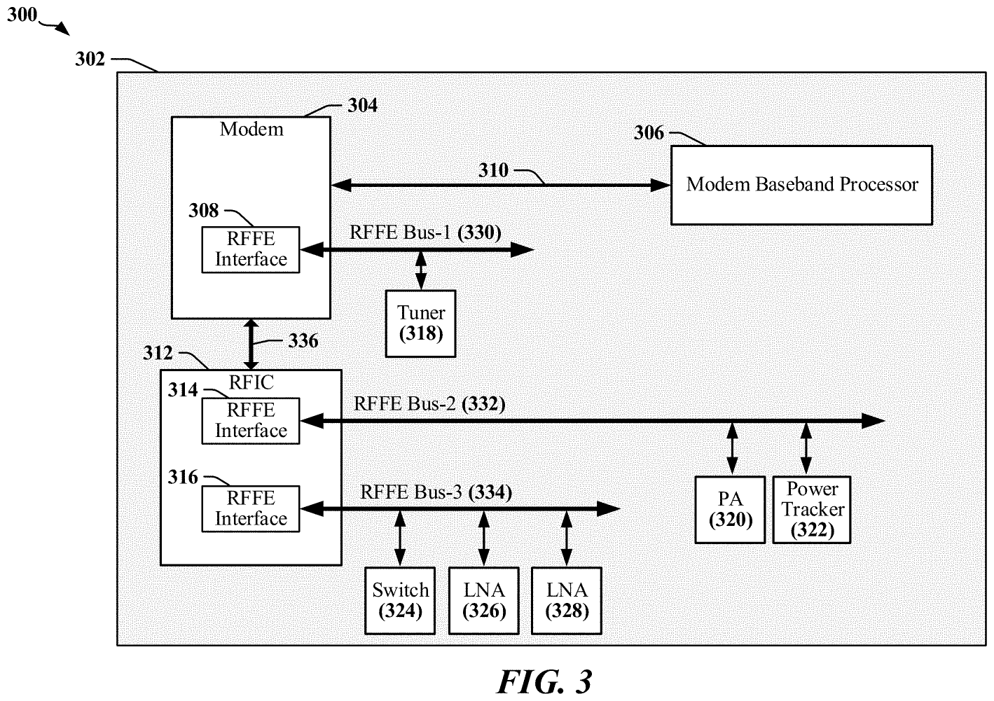

FIG. 3 illustrates certain aspects of an apparatus 300 that includes multiple RFFE buses 330, 332, 334 configured coupled to various RF front-end devices 318, 320, 322, 324, 326, 328. A modem 302 includes an RFFE interface 308 that couples the modem 302 to a first RFFE bus 330. The modem 302 may communicate with a baseband processor 306 and a Radio-Frequency IC (RFIC 312) through one or more communication links 310, 336. The illustrated apparatus 300 may be embodied in one or more of a mobile communication device, a mobile telephone, a mobile computing system, a mobile telephone, a notebook computer, a tablet computing device, a media player, a gaming device, a wearable computing and/or communications device, an appliance, or the like.

In various examples, the apparatus 300 may be implemented with one or more baseband processors 306, modems 304, RFICs 312, multiple communications links 310, 336, multiple RFFE buses 330, 332, 334 and/or other types of buses. The apparatus 300 may include other processors, circuits, modules and may be configured for various operations and/or for a variety of functionalities. In the example illustrated in FIG. 3, the modem 302 is coupled to an RF tuner 318 through its RFFE interface 308 and the first RFFE bus 330. The RFIC 312 may include one or more RFFE interfaces 314, 316, controllers, state machines and/or processors that can configure and control certain aspects of the RF front-end. The RFIC 312 may communicate with a PA 320 and a power tracking module 322 through a first of its RFFE interfaces 314 and the second RFFE bus 330. The RFIC 312 may communicate with a switch 324 and one or more LNAs 326, 328.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency may be measured as the time elapsed between a message becoming available for transmission and the delivery of the message or, in some instances, commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

In certain examples, latency-sensitive messages can include coexistence messages. Coexistence messages are transmitted in a multisystem platform to prevent or reduce instances of certain device types impinging on each other, including for example, switches 324, LNAs 326, 328, PAs 320 and other types of device that operate concurrently in a manner that can generate inter-device interference, or that could potentially cause damage to one or more active devices through high-power electromagnetic interference. Devices that may interfere with one another may exchange coexistence management (CxM) messages to permit each device to signal imminent actions that may result in interference or conflict. CxM messages may be used to manage operation of shared components including a switch 324, LNA 326, 328, PA 320 and/or an antenna.

Multi-drop interfaces such as interfaces governed by RFFE, SPMI, I3C, and similar protocols can reduce the number of physical input/output (I/O) pins used to communicate between multiple devices. Protocols that support communication over a multi-drop serial bus define a datagram structure used to transmit command, control and data payloads. Datagram structures for different protocols define certain common features, including addressing used to select devices to receive or transmit data, clock generation and management, interrupt processing and device priorities. The example of RFFE protocols may be employed to illustrate certain aspects disclosed herein. However, the concepts disclosed herein are applicable to other serial bus protocols and standards.

### Triggers Transmitted Over a Multidrop Bus

Triggers provide a mechanism for RF front-end control, and triggers may be used to coordinate activities of different front-end components. For example, triggers can be used for a variety of purposes including beam steering or beamforming, gain setting, antenna path multiplexer control, etc. In some devices, triggers can be configured, activated and/or actuated over a serial bus operated in accordance with RFFE protocols. In some conventional systems, a Bus Owner Master (BoM) may transmit a command that includes a trigger configuration and an action associated with the configured trigger, such that receipt of the command causes the trigger to be actuated or otherwise take effect or be applied. A trigger configured by the command may be referred to as a self-actuating trigger.

Advances in RF technology and the introduction of increased capabilities in communication devices increase pressure on latency times. For example, the deployment of radio access technologies such as the 5G New Radio technology defined by the 3rd Generation Partnership Project (3GPP) and the 802.11ax WLAN standard defined by the Institute of Electrical and Electronics Engineers (IEEE) 802.11 Working Group can require a 50% reduction in latency at conventional bus clock frequencies, increase complexity of RFFE bus architectures and increase the potential for traffic congestion on the bus. RFFE bus congestion and timing bottlenecks may be expected to exacerbate coexistence issues. For example, increased bus activity may increase bus contention issues where RFFE bus timing is complicated. In these scenarios, a BoM may be prevented from sending the triggers at an exact time needed by slave devices to meet the RF protocol timing.

In some systems, delayed triggers may be used to avoid bus congestion and timing bottlenecks and ensure timely actuation of triggers. A BoM may configure one or more triggers and corresponding timers that control the actual timing of the configured triggers. For example, the BoM may define an action associated with the configured triggers and may activate one or more counters or timers that define a time at which triggers may be actuated. Actuating a trigger causes or initiates the action associated with the trigger. The counter or timer may define the time of actuation as a number of clock cycles in the clock signal transmitted by the BoM to control timing on the serial bus.

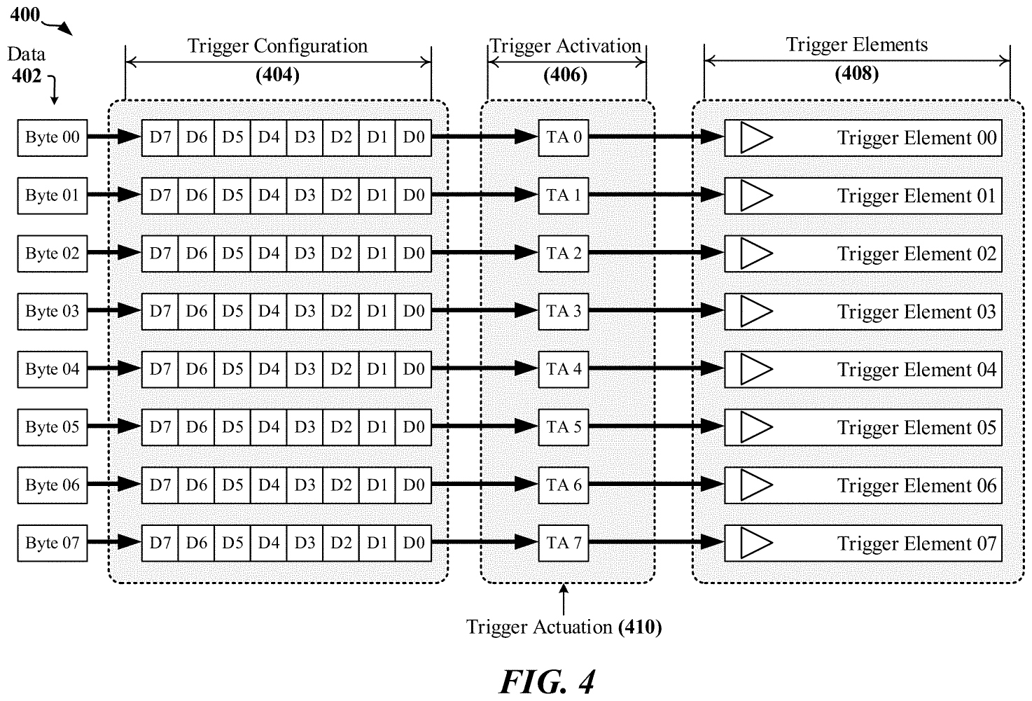

FIG. 4 illustrates an example of a trigger actuation circuit 400 that may be configured to configure, activate and actuate triggers. In the illustrated example, configuration information is received as a plurality of data bytes 402, which may be stored in trigger configuration registers 404. The trigger configuration registers 404 may be written in a configuration transaction conducted over a serial bus, which may be operated in accordance with an RFFE protocol. The contents of the trigger configuration registers 404 may be forwarded to a target for configuration using a timer or counter in a controlling circuit that is configured based on information provided by the BoM, for example.

Trigger activation logic 406 may be configured to enable the contents of the trigger configuration registers 404 to be transferred to respective target devices in response to a trigger command or trigger actuation signal 410 received provided by the controlling circuit. The trigger elements 408 may include switches 324, LNAs 326, 328, PAs 320 and other types of device that operate concurrently in an RF front-end. In one example, a BoM may configure a mask or gating logic that determines which trigger elements 408 are to receive data from the trigger configuration registers 404 during actuation initiated by the trigger actuation signal 410. In another example, the mask or gating logic may determine the trigger elements 408 that are to receive data from the trigger configuration registers 404 during actuation initiated by corresponding trigger actuation signals 410.

Certain aspects disclosed herein provide mechanisms that enable a BoM to configure triggers with reliable delayed actuation. The triggers can be configured before the time defined for actuation, and a slave device may wait for a defined period of time before actuating the trigger. In one example, the BoM can send triggers ahead of time and when bus traffic conditions allow. A slave device may include configurable counters or timers that provide trigger actuation signals 410 based on timing provided by a clock signal transmitted over the serial bus by the BoM.

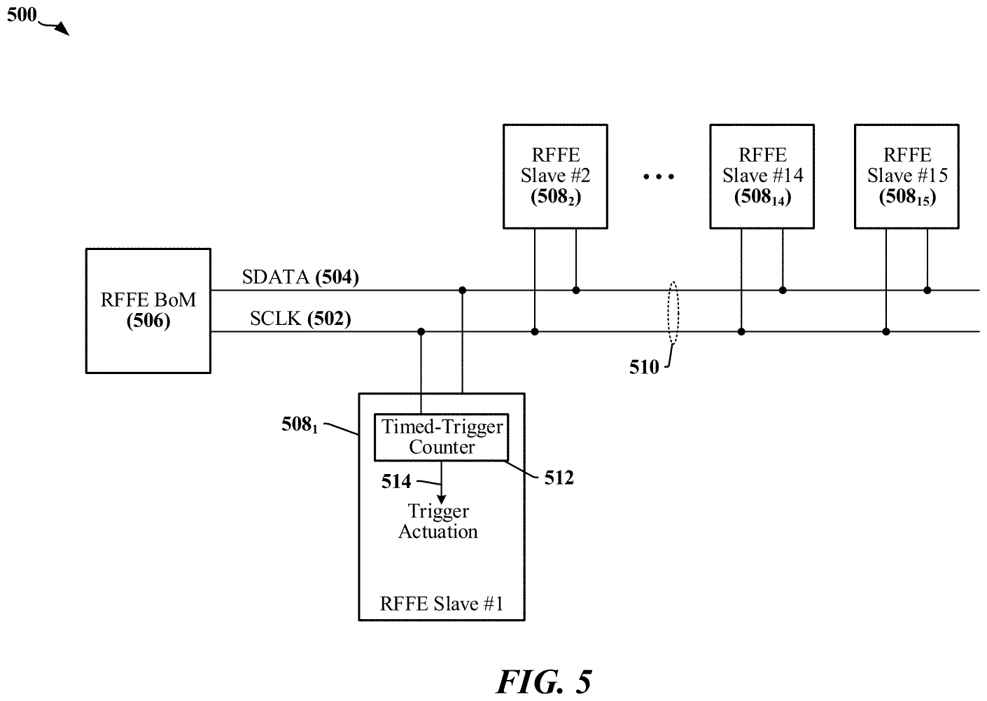

FIG. 5 illustrates an example of a system 500 configured in accordance with certain aspects disclosed herein. In one example, the system 500 includes a serial bus 510 that may be operated according to an RFFE protocol. A BoM 506 and up to 15 slave devices 508₁-5081₅ may be coupled to the serial bus 510. The serial bus 510 includes a first line (SCLK 502) that carries a clock signal and a second line (SDATA 504) that carries a data signal. A first slave device 508₁, for example, includes or incorporates the trigger actuation circuit 400 of FIG. 4. The first slave device 508₁ also includes a counter 512 that may be configured to provide an actuation signal 514. In one example, the counter 512 may be initially configured with a count value that is calculated to provide a desired or identified countdown period when the counter 512 is clocked by the clock signal transmitted on SCLK 502. The counter 512 may be configured to decrement in response to each pulse received from the clock signal, and may be further configured to provide the actuation signal 514 that causes an intended trigger to be fired when the count value reaches zero.

The BoM 506 may initiate or activate the intended trigger, and may be configured to provide clock pulses in a clock signal until the counter value has reached zero. The timing accuracy of the actuation signal 514 typically relies on the pulses being provided in the clock signal at a fixed rate or frequency. The BoM 506 may be configured to provide clock pulses in the clock signal while a transaction is conducted over the serial bus 510. For example, the BoM 506 provides clock pulses in the clock signal that define the timing of bits transmitted in a datagram transmitted over the serial bus 510. The BoM 506 continues to provide clock pulses in the clock signal when transmission of the datagram has been completed and when no further datagrams are available for transmission. The BoM 506 may idle SDATA 504 while continuing to drive the clock signal on SCLK 502. The pulses in the clock signal are provided at the same frequency as pulses provided during transmission of a datagram. The resulting clock signal causes the counter 512 to be decremented while the data signal is idle.

One or more datagrams may become available for transmission while SDATA 504 is idle and while the counter 512 is actively counting. The BoM 506 may initiate the datagrams before the counter 512 has been decremented to a zero count value. An indeterminate number of datagrams may be transmitted while the counter 512 has a non-zero count value. The transmission of each datagram includes transmission of a sequence start condition (SSC), which suppresses clock pulses for two cycles of the clock signal, and this suppression of clock pulses can affect the timing accuracy of the actuation signal 514.

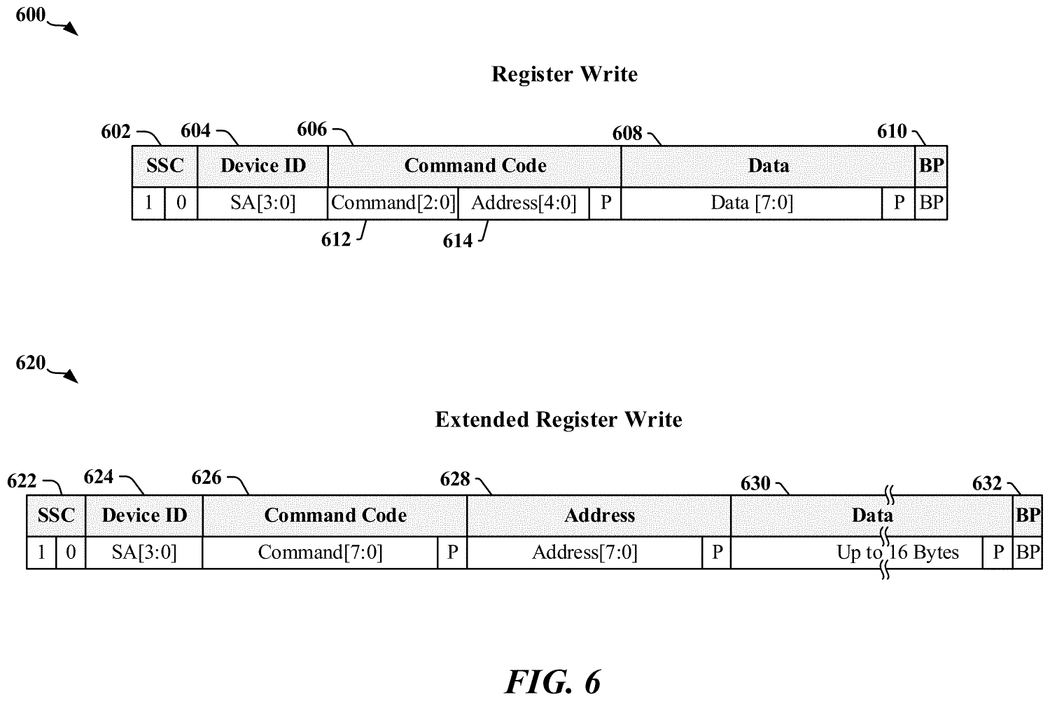

FIG. 6 illustrates examples of datagram structures 600, 620 that are consistent with structures defined by RFFE protocols and that show the transmission of the SSC. The datagram structures 600, 620 are also consistent with or similar to datagram structures defined by other protocols and may be adapted for use in accordance with certain aspects disclosed herein. The datagram structures 600, 620 commence with transmission of a two-bit SSC 602, 622 followed by a four-bit device ID 604, 624. A nine-bit command field 606, 626 is transmitted next. In the Register Write command datagram structure 600, the nine-bit command field 606 includes a three-bit command code 612, a five-bit address field 614 and a parity bit. In the Extended Register Write command datagram structure 620, the nine-bit command field 606 is occupied by an eight-bit command code and a parity bit and followed by an address field 628 that carries an eight-bit register address and a parity bit. In the Register Write command datagram structure 600, a data field 608 carries a single data byte, while in the Extended Register Write command datagram structure 620 the data field 630 carries up to 16 data bytes. Each data byte is transmitted with a parity bit. Bus park signaling 610, 632 terminates the datagram structures 600, 620.

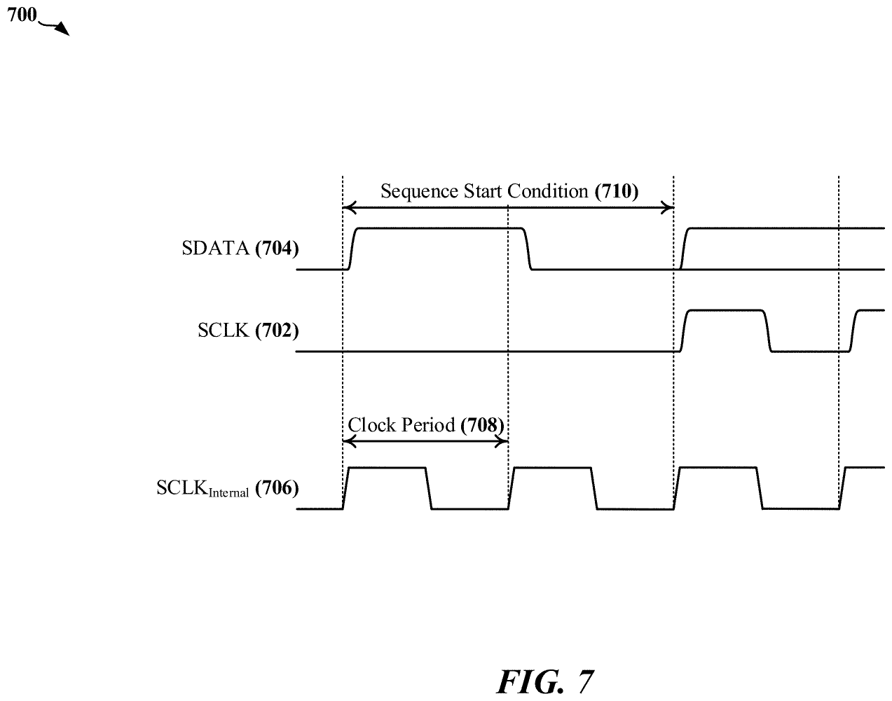

FIG. 7 is a timing diagram 700 that illustrates transmission of an SSC 710 provided in accordance with an RFFE protocol. The timing diagram 700 represents timing from the perspective of a BoM, such as the BoM 506 of FIG. 5. The BoM may generate signals transmitted on SCLK 702 and SDATA 704 based on an internal clock signal 706. The internal clock signal 706 may be provided to a line driver circuit coupled to SCLK 702 and may correspond to the clock signal used to control data transmissions over a serial bus and trigger actuation on certain receiving devices. During transmission of the SSC 710, the internal clock signal 706 may be gated for two clock periods 708. The SSC 710 is detected by receiving devices when SCLK 702 is maintained at the low signaling state and SDATA 704 is driven to the high signaling state for at least one full clock period 708 before being driven to the low signaling state.

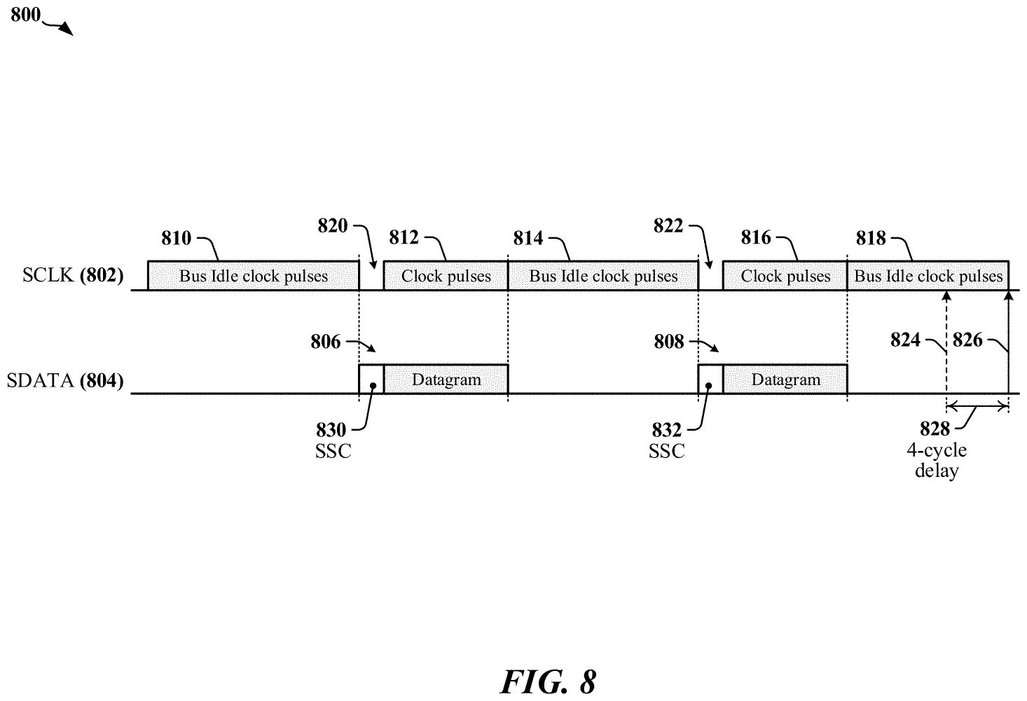

FIG. 8 is a timing diagram 800 that illustrates accumulation of timing inaccuracies caused by transmission of datagrams 806, 808 during timed-trigger operation. A BoM may configure a counter or other timing device to actuate a trigger at a desired point in time 824. The BoM provides clock pulses 810, 814 and 818 on SCLK 802 during periods when SDATA 804 is idle, in addition to clock pulses 812, 816 provided during transmission of the datagrams 806, 808. Two clock pulses 820, 822 are suppressed during transmission of the SSC 830, 832 preceding each datagram 806, 808. In the illustrated example, the point in time 826 at which the trigger is actuated is delayed by the accumulated 4-cycle delay 828 and occurs after the desired point in time 824 for the trigger. The variability in the number of datagrams 806, 808 that can be transmitted during timed-trigger operation can limit the timing accuracy of a trigger actuation signal. An increase in the number of datagrams transmitted during timed-trigger operation can increase trigger-firing inaccuracy with respect to the intended time of firing and can substantially impact system operation.

Certain aspects of this disclosure can increase trigger-firing accuracy by detecting transmission of SSCs and/or datagrams during timed-trigger operation and through the use of an adjusted counter output value to account for suppressed clock pulses associated with the transmission of the SSC.

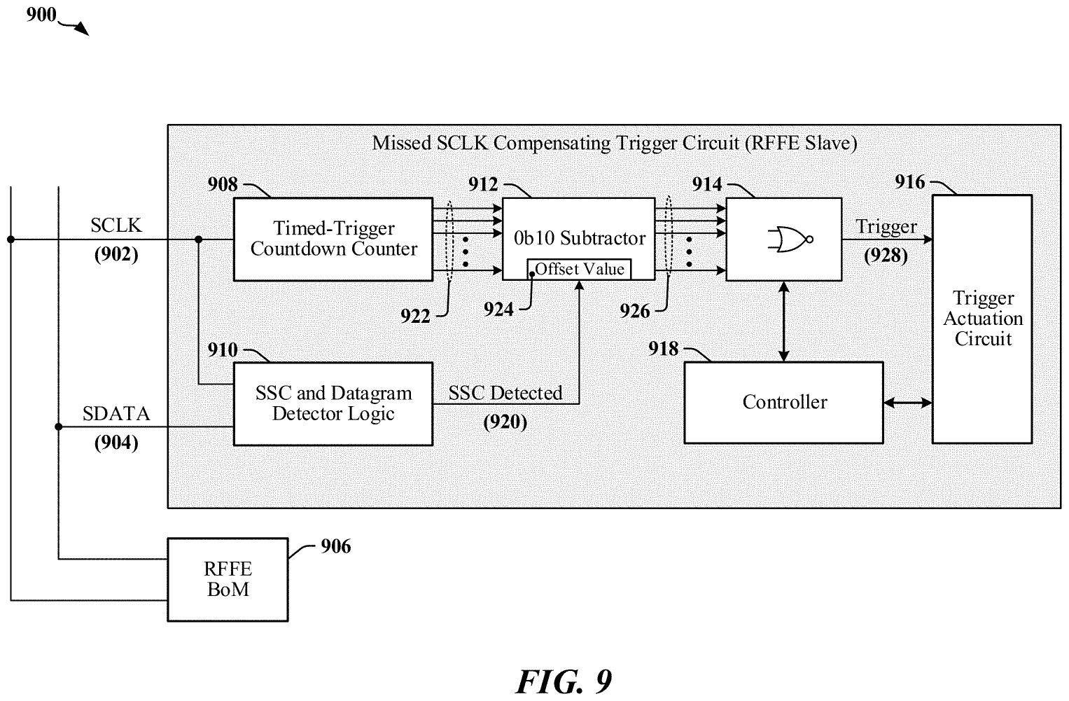

FIG. 9 illustrates a trigger circuit 900 configured to compensate for suppressed clock pulses during timed-trigger operation in accordance with certain aspects of the disclosure. The trigger circuit 900 may be provided in an RFFE slave device and may include a controller 918 that manages and/or configures the operation of the trigger circuit 900. In some instances, the controller 918 may be provided within the slave device external to the trigger circuit and may be configured to manage and/or configure the operation of the trigger circuit 900 and other components of the slave device. For example, the controller 918 may be configured to use a bus interface circuit to monitor SCLK 902 and SDATA 904 for transmissions of SSC or datagrams during timed-trigger operation. The trigger circuit 900 may include an SSC and datagram detector circuit 910 that includes logic that can identify SSCs from a combination of signaling states of SCLK 902 and SDATA 904. The clock signal provided by a BoM 906 is received from SCLK 902 and is coupled to the clock input of a counter 908. In the illustrated example, the counter 908 is configured to decrement its output value 922 in response to each pulses received in the clock signal. The counter output value 922 may be initiated by the BoM 906 prior to a timing operation, or may be initiated based on a preconfigured time value maintained in a register previously configured by the BoM 906. In one example, the BoM 906 may configure a register with a value to be loaded into the counter 908 prior to one or more timing operations.

In the illustrated example, a trigger signal 928 is provided to a trigger actuation circuit 916, which may correspond to the trigger actuation circuit 400 in FIG. 4. The state of the trigger signal 928 may be representative of the counter output value 922. In timing operations where no SSC is detected, the trigger signal 928 may be driven to a high signaling state when the counter output value 922 reaches zero. An associated trigger may be actuated when the trigger signal 928 is in the high signaling state or when the trigger signal 928 transitions to the high signaling state.

In one aspect, the counter output value 922 is provided to an arithmetic circuit 912 that is configured to compensate for suppressed clock pulses in the clock signal received from SCLK 902. In one example, the SSC and datagram detector circuit 910 provides an SSC detection signal 920 that indicates each detection of an SSC transmitted by the BoM 906. In some implementations, the arithmetic circuit 912 may increase an offset value 924 by two (OblO) for each detection of an SSC. The arithmetic circuit 912 may provide, at its output, a compensated count value 926 that represents the result of a subtraction of the offset value 924 from the counter output value 922. The compensated count value 926 is provided to a zero detecting circuit 914 that provides the trigger signal 928.

In some implementations, the counter 908 may be configured to count-up (increment), and the arithmetic circuit 912 may be configured to provide a compensated count value 926 that represents the result of an addition of the offset value 924 to the counter output value 922. In some implementations, the arithmetic circuit 912 may be omitted and the SSC detection signal 920 may be used to decrease the counter output value 922 by two when the counter 908 is configured as a countdown counter. In some implementations, the arithmetic circuit 912 may be omitted and the SSC detection signal 920 may be used to increase the counter output value 922 by two when the counter 908 is configured to count-up.

In one aspect, compensation for suppressed clock pulses may be enabled during timed-trigger operation provided the counter output value 922 has a value of at least two, in the illustrated trigger circuit 900. The compensation for suppressed clock pulses may be enabled during timed-trigger operation provided the counter output value 922 has a count value that is at least two counts short of its trigger value. For example, compensation for suppressed clock pulses may be enabled when a counter 908 will reach its trigger value after at two or more pulses or edges in its clock input.

### Examples of Processing Circuits and Methods

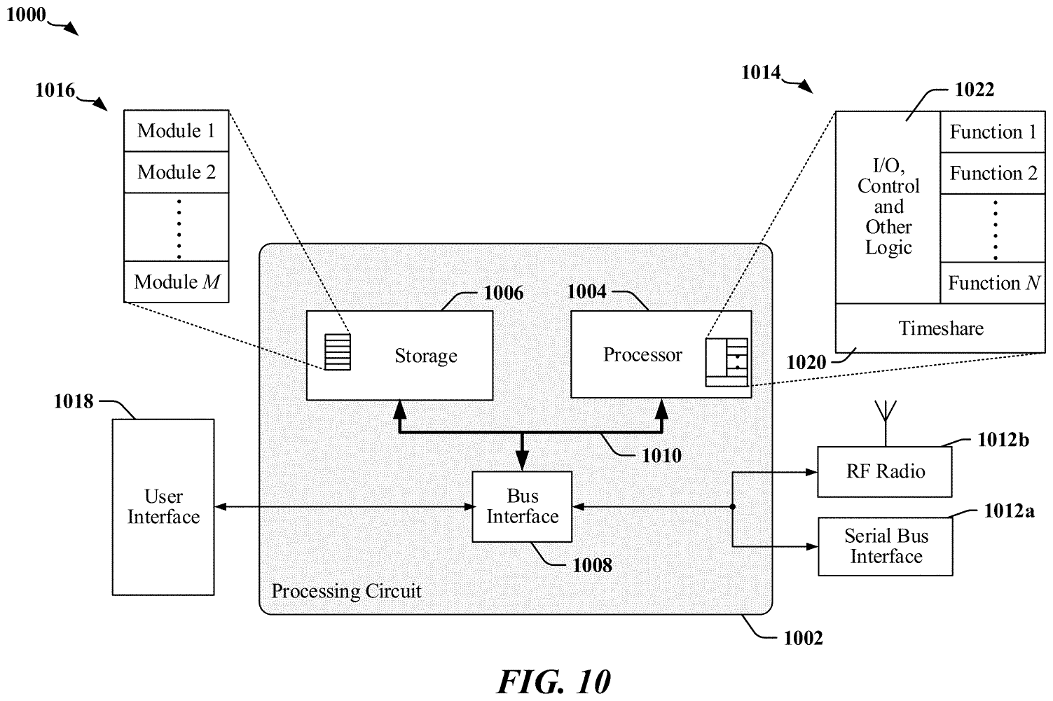

FIG. 10 is a diagram illustrating an example of a hardware implementation for an apparatus 1000. In some examples, the apparatus 1000 may perform one or more functions disclosed herein. In accordance with various aspects of the disclosure, an element, or any portion of an element, or any combination of elements as disclosed herein may be implemented using a processing circuit 1002. The processing circuit 1002 may include one or more processors 1004 that are controlled by some combination of hardware and software modules. Examples of processors 1004 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1004 may include specialized processors that perform specific functions, and that may be configured, augmented or controlled by one of the software modules 1016. The one or more processors 1004 may be configured through a combination of software modules 1016 loaded during initialization, and further configured by loading or unloading one or more software modules 1016 during operation.

In the illustrated example, the processing circuit 1002 may be implemented with a bus architecture, represented generally by the bus 1010. The bus 1010 may include any number of interconnecting buses and bridges depending on the specific application of the processing circuit 1002 and the overall design constraints. The bus 1010 links together various circuits including the one or more processors 1004, and storage 1006. Storage 1006 may include memory devices and mass storage devices, and may be referred to herein as computer-readable media and/or processor-readable media. The bus 1010 may also link various other circuits such as timing sources, timers, peripherals, voltage regulators, and power management circuits. A bus interface 1008 may provide an interface between the bus 1010 and one or more transceivers or interfaces 1012a, 1012b. A transceiver or interface 1012a, 1012b may be provided for each networking technology supported by the processing circuit 1002. In some instances, multiple networking technologies may share some or all of the circuitry or processing modules found in a transceiver or interface 1012a, 1012b. Each transceiver or interface 1012a, 1012b provides a means for communicating with various other apparatus over a transmission medium. In one example, a transceiver or interface 1012a may be used to couple the apparatus 1000 to a multi-wire bus. In another example, a transceiver or interface 1012b may be used to connect the apparatus 1000 to a radio access network. Depending upon the nature of the apparatus 1000, a user interface 1018 (e.g., keypad, display, speaker, microphone, joystick) may also be provided, and may be communicatively coupled to the bus 1010 directly or through the bus interface 1008.

A processor 1004 may be responsible for managing the bus 1010 and for general processing that may include the execution of software stored in a computer-readable medium that may include the storage 1006. In this respect, the processing circuit 1002 may be used to implement any of the methods, functions and techniques disclosed herein. The storage 1006 may be used for storing data that is manipulated by the processor 1004 when executing software, and the software may be configured to implement any one of the methods disclosed herein.

One or more processors 1004 in the processing circuit 1002 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1006 or in an external computer-readable medium. The external computer-readable medium and/or storage 1006 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1006 may also include, by way of example, a carrier wave, a transmission line, and any other suitable medium for transmitting software and/or instructions that may be accessed and read by a computer. Computer-readable media and/or the storage 1006 may reside in the processing circuit 1002, in the processor 1004, external to the processing circuit 1002, or be distributed across multiple entities including the processing circuit 1002. The computer-readable medium and/or storage 1006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1006 may maintain software maintained and/or organized in loadable code segments, modules, applications, programs, etc., which may be referred to herein as software modules 1016. Each of the software modules 1016 may include instructions and data that, when installed or loaded on the processing circuit 1002 and executed by the one or more processors 1004, contribute to a run-time image 1014 that controls the operation of the one or more processors 1004. When executed, certain instructions may cause the processing circuit 1002 to perform functions in accordance with certain methods, algorithms and processes described herein.

Some of the software modules 1016 may be loaded during initialization of the processing circuit 1002, and these software modules 1016 may configure the processing circuit 1002 to enable performance of the various functions disclosed herein. For example, some software modules 1016 may configure internal devices and/or logic circuits 1022 of the processor 1004, and may manage access to external devices such as a transceiver or interface 1012a, 1012b, the bus interface 1008, the user interface 1018, timers, mathematical coprocessors, and so on. The software modules 1016 may include a control program and/or an operating system that interacts with interrupt handlers and device drivers, and that controls access to various resources provided by the processing circuit 1002. The resources may include memory, processing time, access to a transceiver or interface 1012a, 1012b, the user interface 1018, and so on.

One or more processors 1004 of the processing circuit 1002 may be multifunctional, whereby some of the software modules 1016 are loaded and configured to perform different functions or different instances of the same function. The one or more processors 1004 may additionally be adapted to manage background tasks initiated in response to inputs from the user interface 1018, the transceiver or interface 1012a, 1012b, and device drivers, for example. To support the performance of multiple functions, the one or more processors 1004 may be configured to provide a multitasking environment, whereby each of a plurality of functions is implemented as a set of tasks serviced by the one or more processors 1004 as needed or desired. In one example, the multitasking environment may be implemented using a timesharing program 1020 that passes control of a processor 1004 between different tasks, whereby each task returns control of the one or more processors 1004 to the timesharing program 1020 upon completion of any outstanding operations and/or in response to an input such as an interrupt. When a task has control of the one or more processors 1004, the processing circuit 1002 is effectively specialized for the purposes addressed by the function associated with the controlling task. The timesharing program 1020 may include an operating system, a main loop that transfers control on a round-robin basis, a function that allocates control of the one or more processors 1004 in accordance with a prioritization of the functions, and/or an interrupt driven main loop that responds to external events by providing control of the one or more processors 1004 to a handling function.

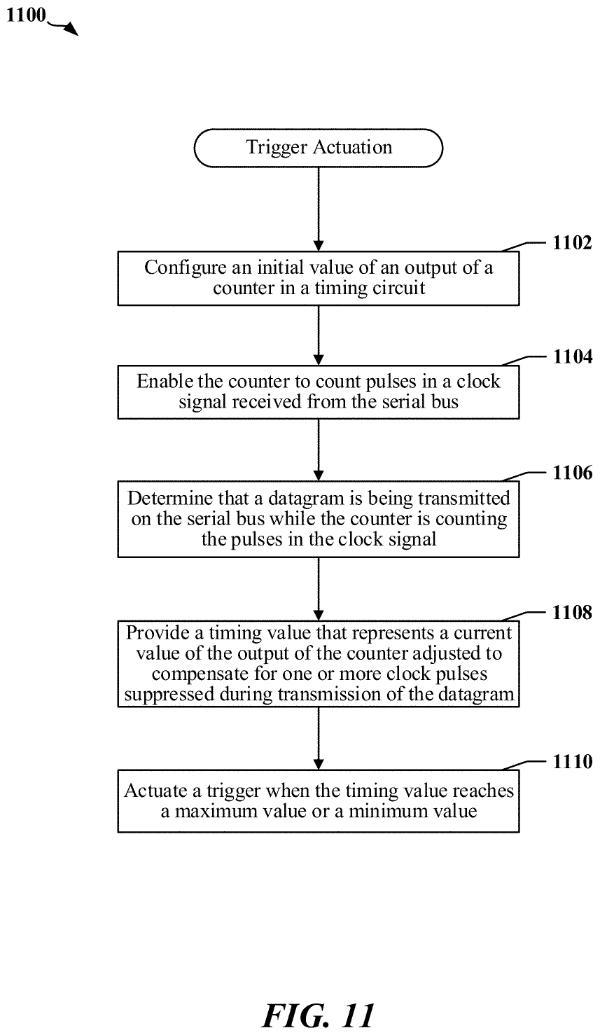

FIG. 11 is a flowchart 1100 of a method that may be performed by a device coupled to a serial bus. In one example, the serial bus may be operated in accordance with an RFFE protocol. At block 1102, the device may configure an initial value of an output of a counter in a timing circuit. At block 1104, the device may enable the counter to count pulses in a clock signal received from the serial bus. At block 1106, the device may determine that a datagram is being transmitted on the serial bus while the counter is counting the pulses in the clock signal. At block 1108, the device may provide a timing value that represents a current value of the output of the counter adjusted to compensate for one or more clock pulses suppressed during transmission of the datagram. At block 1110, the device may provide a trigger when the timing value reaches a maximum value or a minimum value. The datagram may be configured in accordance with an RFFE or SPMI protocol, for example.

In certain implementations, the device may determine that the datagram is being transmitted on the serial bus by detecting an SSC on the serial bus. Two clock pulses in the clock signal are suppressed during transmission of the SSC. When a number (N) of datagrams are transmitted while the counter is counting the pulses in the clock signal, the current value of the output of the counter may be adjusted to compensate for the N×2 clock pulses suppressed during transmission of the datagram.

In one example, the counter may be configured to count pulses by counting down from the initial value. In this example, the device may provide the timing value by subtracting a number representing the one or more clock pulses suppressed during transmission of the datagram from the current value of the counter output. An arithmetic circuit, such as a fixed-value subtractor may be used to adjust the current value of the output of the counter. In the example of a countdown counter, the trigger may be provided when the timing value reaches zero. In some instances, the trigger may be provided when the counter overflows.

In another example, the counter may be configured to count pulses by counting up from the initial value. In this example, the device may provide the timing value by adding a number representing the one or more clock pulses suppressed during transmission of the datagram to the current value of the counter output. An arithmetic circuit, such as a fixed-value adder may be used to adjust the current value of the output of the counter. In the example of a count-up counter, the trigger may be provided when the timing value reaches zero. In some instances, the trigger may be provided when the counter overflows.

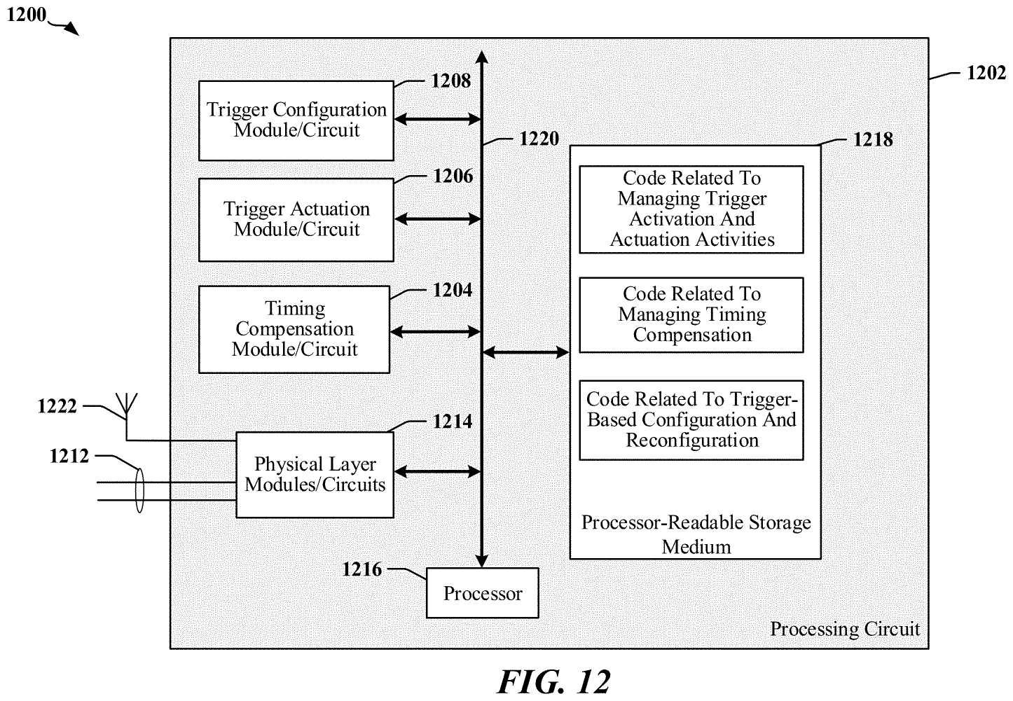

FIG. 12 is a diagram illustrating a simplified example of a hardware implementation for an apparatus 1200 employing a processing circuit 1202. The processing circuit 1202 typically has a controller or processor 1216 that may include one or more microprocessors, microcontrollers, digital signal processors, sequencers and/or state machines. The processing circuit 1202 may be implemented with a bus architecture, represented generally by the bus 1220. The bus 1220 may include any number of interconnecting buses and bridges depending on the specific application of the processing circuit 1202 and the overall design constraints. The bus 1220 links together various circuits including one or more processors and/or hardware modules, represented by the controller or processor 1216, the modules or circuits 1204, 1206 and 1208 and the processor-readable storage medium 1218. One or more physical layer circuits and/or modules 1214 may be provided to support communications over a communication link implemented using a serial bus 1212, through an antenna or antenna array 1222 (to a radio access network for example), and so on. The bus 1220 may also link various other circuits such as timing sources, peripherals, voltage regulators, and power management circuits, which are well known in the art, and therefore, will not be described any further.

The processor 1216 is responsible for general processing, including the execution of software, code and/or instructions stored on the processor-readable storage medium 1218. The processor-readable storage medium 1218 may be implemented using a non-transitory storage medium. The software, when executed by the processor 1216, causes the processing circuit 1202 to perform the various functions described supra for any particular apparatus. The processor-readable storage medium 1218 may be used for storing data that is manipulated by the processor 1216 when executing software. The processing circuit 1202 further includes at least one of the modules 1204, 1206 and 1208. The modules 1204, 1206 and 1208 may be software modules running in the processor 1216, resident/stored in the processor-readable storage medium 1218, one or more hardware modules coupled to the processor 1216, or some combination thereof. The modules 1204, 1206 and 1208 may include microcontroller instructions, state machine configuration parameters, or some combination thereof

In one configuration, the apparatus 1200 includes modules and/or circuits 1208 adapted to maintain configuration information relating trigger actuation commands to triggers and configuration information for implementing delays when the delayed trigger option is used. The apparatus 1200 may include modules and/or circuits 1206 adapted to generate trigger activation signals in response to trigger actuation commands. The apparatus 1200 may include modules and/or circuits 1204 adapted to configure, manage or operate as timing compensation circuits.

In one example, the apparatus 1200 includes physical layer circuits and/or modules 1214 that implement an interface circuit adapted to couple the apparatus 1200 to a serial bus 1212, including a first serial bus. The apparatus 1200 may have a trigger handler implemented using logic circuits and/or the processor 1216. The interface circuit may be configured to receive a clock signal from the serial bus. The apparatus 1200 may further include a counter configured to count pulses in the clock signal. The apparatus 1200 may further include a datagram detector circuit configured to determine that a datagram is being transmitted on the serial bus while the counter is counting the pulses in the clock signal. The apparatus 1200 may further include a controller configured to configure an initial value of an output of the counter, and enable the counter to count the pulses in the clock signal. The apparatus 1200 may further include an arithmetic circuit configured to provide a timing value that represents a current value of the output of the counter adjusted to compensate for one or more clock pulses suppressed during transmission of the datagram. A trigger may be provided when the timing value reaches a maximum value or a minimum value. In some implementations, the datagram is configured in accordance with an RFFE or SPMI protocol, for example.

In one example, the datagram detector circuit is further configured to detect an SSC on the serial bus. Two clock pulses in the clock signal may be suppressed during transmission of the SSC.

In some implementations, the counter is further configured to count pulses by counting down from the initial value. The arithmetic circuit may be further configured to provide the timing value by subtracting a number representing the one or more clock pulses suppressed during transmission of the datagram from the current value of the counter output. The trigger may be provided when the timing value reaches zero. In some instances, the trigger may be provided when the counter overflows.

In some implementations, the counter is configured to count pulses by counting up from the initial value. The arithmetic circuit may be further configured to provide the timing value by adding a number representing the one or more clock pulses suppressed during transmission of the datagram to the current value of the counter output. The trigger may be provided when the timing value reaches zero. In some instances, the trigger may be provided when the counter overflows.

The processor-readable storage medium 1218 may include instructions that cause the processing circuit 1202 to configure an initial value of an output of a counter in a timing circuit, enable the counter to count pulses in a clock signal received from the serial bus determine that a datagram is being transmitted on the serial bus while the counter is counting the pulses in the clock signal, provide a timing value that represents a current value of the output of the counter adjusted to compensate for one or more clock pulses suppressed during transmission of the datagram, and provide a trigger when the timing value reaches a maximum value or a minimum value. The datagram may be configured in accordance with RFFE protocols or SPMI protocols.

The processor-readable storage medium 1218 may include further instructions that cause the processing circuit 1202 to detect an SSC on the serial bus. Two clock pulses in the clock signal may be suppressed during transmission of the SSC.

In some instances, the counter is configured to count pulses by counting down from the initial value. The processor-readable storage medium 1218 may include further instructions that cause the processing circuit 1202 to provide the timing value by subtracting a number representing the one or more clock pulses suppressed during transmission of the datagram from the current value of the counter output. The processor-readable storage medium 1218 may include further instructions that cause the processing circuit 1202 to provide the trigger when the timing value reaches zero or when the counter overflows.

In some instances, the counter is configured to count pulses by counting up from the initial value. The processor-readable storage medium 1218 may include further instructions that cause the processing circuit 1202 to provide the timing value by adding a number representing the one or more clock pulses suppressed during transmission of the datagram to the current value of the counter output. The processor-readable storage medium 1218 may include further instructions that cause the processing circuit 1202 to provide the trigger when the timing value reaches zero or when the counter overflows.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method for triggering a device coupled to a serial bus, comprising:
configuring an initial value of an output of a counter in a timing circuit;
enabling the counter to count pulses in a clock signal received from the serial bus;
determining that a datagram is being transmitted on the serial bus while the counter is counting the pulses in the clock signal;
providing a timing value that represents a current value of the output of the counter adjusted to compensate for one or more clock pulses suppressed during transmission of the datagram; and
providing a trigger when the timing value reaches a maximum value or a minimum value.

2. The method of claim 1, wherein the datagram is configured in accordance with a Radio Frequency Front-End (RFFE) protocol, and wherein two clock pulses in the clock signal are suppressed during transmission of the datagram.

3. The method of claim 1, wherein determining that the datagram is being transmitted on the serial bus comprises:
detecting a sequence start condition (SSC) on the serial bus, wherein two clock pulses in the clock signal are suppressed during transmission of the SSC.

4. The method of claim 1, wherein the counter is configured to count the pulses by counting down from the initial value.

5. The method of claim 4, further comprising:
providing the timing value by subtracting a number representing the one or more clock pulses suppressed during transmission of the datagram from the current value of the output of the counter.

6. The method of claim 4, further comprising:
providing the trigger when the timing value reaches zero.

7. The method of claim 1, wherein the counter is configured to count the pulses by counting up from the initial value.

8. The method of claim 7, further comprising:
providing the timing value by adding a number representing the one or more clock pulses suppressed during transmission of the datagram to the current value of the output of the counter.

9. The method of claim 7, further comprising:
providing the trigger when the timing value reaches zero.

10. A data communication apparatus comprising:
an interface circuit adapted to couple the data communication apparatus to a serial bus and configured to receive a clock signal from the serial bus;
a counter configured to count pulses in the clock signal;
a datagram detector circuit configured to:
determine that a datagram is being transmitted on the serial bus while the counter is counting the pulses in the clock signal; and
a controller configured to:
configure an initial value of an output of the counter; and
enable the counter to count the pulses in the clock signal; and
an arithmetic circuit configured to:
provide a timing value that represents a current value of the output of the counter adjusted to compensate for one or more clock pulses suppressed during transmission of the datagram,
wherein a trigger is provided when the timing value reaches a maximum value or a minimum value.

11. The data communication apparatus of claim 10, wherein the datagram is configured in accordance with a Radio Frequency Front-End (RFFE) protocol, and wherein two clock pulses in the clock signal are suppressed during transmission of the datagram.

12. The data communication apparatus of claim 10, wherein the datagram detector circuit is further configured to:
detect a sequence start condition (SSC) on the serial bus, wherein the SSC indicates transmission of the datagram, and wherein two clock pulses in the clock signal are suppressed during transmission of the SSC.

13. The data communication apparatus of claim 10, wherein the counter is further configured to count the pulses by counting down from the initial value.

14. The data communication apparatus of claim 13, wherein the arithmetic circuit is further configured to:
provide the timing value by subtracting a number representing the one or more clock pulses suppressed during transmission of the datagram from the current value of the output of the counter.

15. The data communication apparatus of claim 13, wherein the trigger is provided when the timing value reaches zero.

16. The data communication apparatus of claim 10, wherein the counter is configured to count the pulses by counting up from the initial value.

17. The data communication apparatus of claim 16, wherein the arithmetic circuit is further configured to:
provide the timing value by adding a number representing the one or more clock pulses suppressed during transmission of the datagram to the current value of the output of the counter.

18. The data communication apparatus of claim 16, wherein the trigger is provided when the timing value reaches zero.

19. A processor-readable storage medium having one or more instructions which, when executed by at least one processor of a processing circuit in a receiver, cause the at least one processor to:
configure an initial value of an output of a counter in a timing circuit;
enable the counter to count pulses in a clock signal received from a serial bus;
determine that a datagram is being transmitted on the serial bus while the counter is counting the pulses in the clock signal;
provide a timing value that represents a current value of the output of the counter adjusted to compensate for one or more clock pulses suppressed during transmission of the datagram; and
provide a trigger when the timing value reaches a maximum value or a minimum value.

20. The storage medium of claim 19, wherein the datagram is configured in accordance with a Radio Frequency Front-End (RFFE) protocol, and wherein two clock pulses in the clock signal are suppressed during transmission of the datagram.

21. The storage medium of claim 19, further comprising instructions that cause the at least one processor to:
detect a sequence start condition (SSC) on the serial bus, wherein two clock pulses in the clock signal are suppressed during transmission of the SSC.

22. The storage medium of claim 19, wherein the counter is configured to count the pulses by counting down from the initial value.

23. The storage medium of claim 22, further comprising instructions that cause the at least one processor to:
provide the timing value by subtracting a number representing the one or more clock pulses suppressed during transmission of the datagram from the current value of the output of the counter.

24. The storage medium of claim 22, further comprising instructions that cause the at least one processor to:
provide the trigger when the timing value reaches zero.

25. The storage medium of claim 19, wherein the counter is configured to count the pulses by counting up from the initial value.

26. The storage medium of claim 25, further comprising instructions that cause the at least one processor to:
provide the timing value by adding a number representing the one or more clock pulses suppressed during transmission of the datagram to the current value of the output of the counter.

27. The storage medium of claim 25, further comprising instructions that cause the at least one processor to:
provide the trigger when the timing value reaches zero.

28. A data communication apparatus comprising:
means for timing a trigger, wherein the means for timing the trigger includes a counter configured to count pulses in a clock signal received from a serial bus, wherein an output of the counter is initially configured with an initial value;
means for determining that a datagram is being transmitted on the serial bus while the counter is counting the pulses in the clock signal; and
means for providing a timing value that represents a current value of the output of the counter adjusted to compensate for one or more clock pulses suppressed during transmission of the datagram,
wherein the trigger is provided when the timing value reaches a maximum value or a minimum value.

29. The data communication apparatus of claim 28, wherein the means for determining that the datagram is being transmitted on the serial bus is configured to:
detect a sequence start condition (SSC) on the serial bus, wherein two clock pulses in the clock signal are suppressed during transmission of the SSC.

30. The data communication apparatus of claim 28, wherein the counter is configured to count the pulses by counting down from the initial value, and wherein the means for providing the timing value is configured to:
provide the timing value by subtracting a number representing the one or more clock pulses suppressed during transmission of the datagram from the current value of the output of the counter, wherein the trigger is provided when the timing value reaches zero.
